(19) United States
(12) Patent Application Publication
(10) Pub. No.: US 2023/0395940 A1
(43) Pub. Date: Dec. 7, 2023

(54) NONAQUEOUS ELECTROLYTE SECONDARY BATTERY SEPARATOR

(71) Applicant: Sumitomo Chemical Company, Limited, Tokyo (JP)

(72) Inventor: Tomoaki OZEKI, Niihama-shi (JP)

(21) Appl. No.: 18/203,546

(22) Filed: May 30, 2023

(30) Foreign Application Priority Data
Jun. 2, 2022 (JP) 2022-090361

(51) Int. Cl. H01M 50/457; H01M 50/417; H01M 50/423; H01M 50/449

(52) U.S. Cl. CPC H01M 50/457; H01M 50/449; H01M 50/423; H01M 50/417

(57) ABSTRACT

Provided is a nonaqueous electrolyte secondary battery separator that can prevent a decrease in battery characteristics and/or safety caused by a deformation of a separator due to stress resulting from volume expansion of a negative electrode during charge and discharge. The nonaqueous electrolyte secondary battery separator has a maximum value of a second derivative value of not less than 0.15 which has been calculated based on first derivative values obtained at intervals of 0.5 mm of an elongation amount in a range of a value of X of 0 mm to 7.0 mm on a stress-strain curve obtained from a result of a tension test.

This Nonprovisional application claims priority under 35 U.S.C. § 119 on Patent Application No. 2022-090361 filed in Japan on Jun. 2, 2022, the entire contents of which are hereby incorporated by reference.

### TECHNICAL FIELD

The present invention relates to a separator for a nonaqueous electrolyte secondary battery (hereinafter, referred to as a “nonaqueous electrolyte secondary battery separator”).

### BACKGROUND ART

Nonaqueous electrolyte secondary batteries, particularly lithium-ion secondary batteries, have high energy densities, and are thus in wide use as batteries for personal computers, mobile telephones, portable information terminals, and the like. Recently, such nonaqueous electrolyte secondary batteries have been developed as batteries for vehicles.

Here, one of properties demanded for a nonaqueous electrolyte secondary battery separator (hereafter also referred to as “separator”) is having excellent heat resistance. Examples of such a conventional separator includes a separator disclosed in Patent Literature 1. The separator has a configuration in which a porous layer containing inorganic particles and a heat-resistant resin is formed on at least one surface of a porous base material.

### CITATION LIST

### Patent Literature

[Patent Literature 1]
International Publication No. WO 2018/155288

### SUMMARY OF INVENTION

### Technical Problem

In recent years, with an increase in a capacity of nonaqueous electrolyte secondary batteries, there has been progress in developing nonaqueous electrolyte secondary batteries that use, as a negative electrode, an alloy-based negative electrode containing Si or the like.

However, when a conventional separator (e.g., Patent Literature 1) is used for the nonaqueous electrolyte secondary battery, there has been a problem that the separator is deformed due to stress resulting from volume expansion of the negative electrode during charge and discharge, and this causes a decrease in battery characteristics and/or safety.

Under the circumstances, an object of an aspect of the present invention is to provide a separator that can prevent a decrease in battery characteristics and/or safety caused due to a deformation of a separator due to stress resulting from volume expansion of a negative electrode during charge and discharge.

### Solution to Problem

As a method for preventing the above decrease in battery characteristics and/or safety, a method is generally considered in which a weight per unit area of a porous layer is increased in a separator in which the porous layer containing a heat-resistant resin is formed on a porous base material. However, as a result of diligent study by the inventors of the present invention, it has been found that there are cases where it is impossible to prevent the occurrence of the above problem by merely increasing the weight per unit area. Meanwhile, the inventors of the present invention have found that the occurrence of the above problem can be prevented when using a separator which provides a stress-strain curve having a specific shape (described later) obtained from a result of a tension test. Based on this finding, the inventors of the present invention have conceived of the present invention.

An aspect of the present invention is a nonaqueous electrolyte secondary battery separator including a polyolefin porous film and a porous layer formed on one surface or on both surfaces of the polyolefin porous film, the porous layer containing a heat-resistant resin, and a maximum value of a second derivative value being not less than 0.15, where the second derivative value is calculated based on first derivative values which have been obtained at intervals of 0.5 mm of an elongation amount in a range of a value of X of 0 mm to 7.0 mm on a stress-strain curve, and the stress-strain curve is obtained from a result of a tension test carried out with respect to the nonaqueous electrolyte secondary battery separator while setting an elongation amount as an X-axis and stress as a Y-axis.

### Advantageous Effects of Invention

The nonaqueous electrolyte secondary battery separator in accordance with an embodiment of the present invention brings about an effect of obtaining a nonaqueous electrolyte secondary battery having excellent battery characteristics and/or excellent safety, by preventing the occurrence of the above problem.

### BRIEF DESCRIPTION OF DRAWINGS

FIG. 1 is a diagram indicating a stress-strain curve which is obtained from a result of a tension test carried out with respect to a nonaqueous electrolyte secondary battery separator described in Example 2.

### DESCRIPTION OF EMBODIMENTS

The following description will discuss embodiments of the present invention. Note, however, that the present invention is not limited to these embodiments. The present invention is not limited to arrangements described below, but may be altered in various ways by a skilled person within the scope of the claims. The present invention also encompasses, in its technical scope, any embodiment derived by appropriately combining technical means disclosed in differing embodiments. Any numerical range expressed as “A to B” herein means “not less than A and not more than B” unless otherwise stated.

Herein, the term “machine direction” (MD) refers to a direction which a polyolefin resin composition in sheet form and a porous film are conveyed in the below-described method of producing the porous film. The term “transverse direction” (TD) refers to a direction which is (i) perpendicular to the MD and (ii) parallel to the surface of the polyolefin resin composition in sheet form and the surface of the porous film.

### Embodiment 1: Nonaqueous Electrolyte Secondary Battery Separator

A nonaqueous electrolyte secondary battery separator in accordance with Embodiment 1 of the present invention is a nonaqueous electrolyte secondary battery separator including a polyolefin porous film and a porous layer formed on one surface or on both surfaces of the polyolefin porous film, the porous layer containing a heat-resistant resin, and a maximum value of a second derivative value being not less than 0.15, where the second derivative value is calculated based on first derivative values which have been obtained at intervals of 0.5 mm of an elongation amount in a range of a value of X of 0 mm to 7.0 mm on a stress-strain curve, and the stress-strain curve is obtained from a result of a tension test carried out with respect to the nonaqueous electrolyte secondary battery separator while setting an elongation amount as an X-axis and stress as a Y-axis.

[Maximum Value of Second Derivative Value]

In an embodiment of the present invention, the “maximum value of a second derivative value” is calculated based on a stress-strain curve that is obtained from a result of a predetermined tension test carried out with respect to the nonaqueous electrolyte secondary battery separator. That is, the maximum value of the second derivative value is calculated based on first derivative values which have been obtained at intervals of 0.5 mm of an elongation amount in a range of a value of X of 0 mm to 7.0 mm on the stress-strain curve obtained while setting an elongation amount as an X-axis and stress as a Y-axis. The predetermined tension test is a method which is carried out in conformity to the JIS K7127 standard. The “maximum value of the second derivative value” is calculated by a method including the following steps (a) through (e).
(a) The separator is punched out with a JIS K6251-3 dumbbell (distance between marked lines 20 mm, width of 5 mm) such that the MD is a longitudinal direction of the separator, so that a measurement sample is obtained.
(b) The measurement sample obtained in step (a) is elongated in the MD at a rate of 10 mm/min, and a load (stress) and an elongation amount until the measurement sample is completely broken are measured. At this time, data is obtained every time the elongation amount increases by 0.02 mm. More specifically, every time the elongation amount changes by 0.02 mm, the load (stress) applied at that time is measured.
(c) The elongation amount (unit: mm) and the stress (load) (unit: MPa) obtained in step (b) are plotted while setting the elongation amount as an X-axis (horizontal axis) and the stress as a Y-axis (vertical axis), and thus a stress-strain curve is obtained.
(d) In a range of a value of X of 0 mm to 7.0 mm on the stress-strain curve obtained in step (c), inclinations (first derivative values) of the load are calculated at intervals of 0.5 mm of the elongation amount. That is, the elongation amount is partitioned into sections at intervals of 0.5 mm (e.g., 0.0 mm to 0.5 mm, 0.5 mm to 1.0 mm), and then an inclination obtained when the stress-strain curve is approximated to a straight line is calculated for each of the sections, and thus a “first derivative value” is obtained. This calculation is carried out until the elongation amount reaches 7.0 mm. Note, however, that, if the measurement sample (i.e., the separator) is completely broken before the elongation amount reaches 7.0 mm, the first derivative value is calculated in each of sections in a calculable range, i.e., a range of the elongation amount until the measurement sample is completely broken.
(e) Among the first derivative values obtained in step (d) in the respective sections, a difference between first derivative values of two successive sections is calculated as a “second derivative value”. For example, a difference between first derivative values of two successive sections (e.g., a first derivative value of a section with an elongation amount of 0.0 mm to 0.5 mm and a first derivative value of a section with an elongation amount of 0.5 mm to 1.0 mm) is obtained, and the obtained value is regarded as a second derivative value. Next, a difference between the first derivative value of the section with the elongation amount of 0.5 mm to 1.0 mm and a first derivative value of a section with an elongation amount of 1.0 mm to 1.5 mm is obtained, and the obtained value is regarded as a second derivative value. This operation is repeated until a section with an elongation amount of 7.0 mm. Subsequently, a maximum value among the calculated “second derivative values” which have been each obtained in two successive sections is regarded as the “maximum value of the second derivative value”. Thus, a maximum value of the second derivative value is calculated based on the first derivative values which have been obtained at intervals of 0.5 mm of an elongation amount.

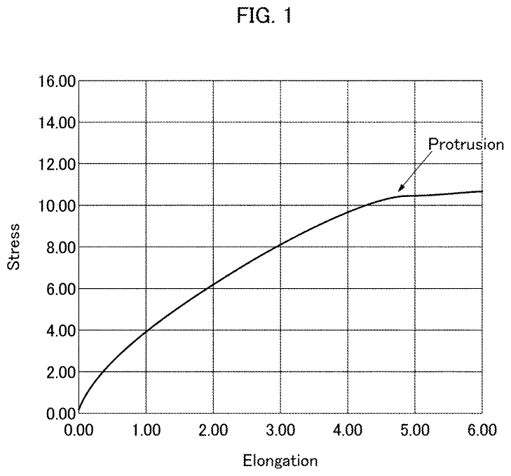

The following description will discuss an example of a stress-strain curve which is obtained from a result of the tension test carried out with respect to the separator in accordance with an embodiment of the present invention, with reference to FIG. 1. FIG. 1 shows a stress-strain curve which is obtained from a result of a tension test carried out with respect to a nonaqueous electrolyte secondary battery separator described in Example 2 (described later). The “maximum value of the second derivative value” of the separator is not less than 0.15. The fact that the “maximum value of the second derivative value” is not less than 0.15 means that a so-called “protrusion” is present in a range of elongation amount of 0 mm to 7.0 mm on the stress-strain curve, as shown in FIG. 1. The term “protrusion” refers to a part at which, on the stress-strain curve, a stress amount corresponding to a predetermined elongation amount varies (decreases) greatly.

The “first derivative value” represents a magnitude of stress which is necessary in the tension test to elongate, by an additional predetermined elongation amount (0.5 mm), a separator which has been elongated by a particular elongation amount. The second derivative value represents a change in the magnitude of that necessary stress. In other words, the second derivative value represents ease of deformation of the separator when the separator is elongated by a particular elongation amount.

Here, the separator includes a polyolefin porous film (hereafter simply referred to also as “porous film”), and a porous layer which is formed on one surface or on both surfaces of the polyolefin porous film. In the tension test, the separator is typically elongated more easily as the elongation amount increases because, first, at least a portion of the porous layer is broken. In this case, stress necessary for the separator to be elongated by a predetermined amount is greatly decreased. Subsequently, as the entire separator is gradually broken, the stress necessary for elongating the separator by a predetermined amount decreases. At that time, an amount of decrease in stress necessary for elongating the separator by a predetermined amount is less than an amount of decrease in stress applied when at least a portion of the porous layer is broken.

As such, when the “second derivative value” reaches a maximum value, at least a portion of the porous layer is broken. Therefore, the fact that the “maximum value of the second derivative value” is not less than 0.15 means that, due to breakage of at least a portion of the porous layer, an amount of decrease in stress which is necessary for the separator to be elongated by a predetermined amount is large, and the separator is more easily elongated. In other words, in the separator in which the “maximum value of the second derivative value” is not less than 0.15, the stress necessary for a predetermined amount of elongation increases greater because the porous layer is formed. Therefore, the separator is more difficult to elongate.

As described above, when at least a portion of the porous layer is broken, the stress necessary for the separator to be elongated by a predetermined amount is decreased. The amount of decrease in the stress can vary depending on, for example, a proportion between, in the separator, a part that is easily deformed and a part that is not easily deformed with respect to externally applied stress, and ease of deformation (rigidity) of each of the parts. Note that the part which is easily deformed is, for example, a porous film, and the part which is not easily deformed is, for example, the porous layer. The proportion between the part which is easily deformed and the part which is not easily deformed, the ease of deformation (rigidity) of each of the parts, and the like are also elements for determining ease of deformation of the separator before at least a portion of the porous layer is broken. In addition, when a nonaqueous electrolyte secondary battery is in operation, the separator is considered to be subjected to stress resulting from volume expansion of a negative electrode during charge and discharge, to an extent that at least a portion of the porous layer is not broken.

As described above, the separator in accordance with an embodiment of the present invention has the “maximum value of the second derivative value” of not less than 0.15, and this makes it possible to control the foregoing elements to fall within a specific range in which the separator is more difficult to elongate. Therefore, the separator is not easily elongated (deformed) even with respect to stress resulting from volume expansion of the negative electrode during charge and discharge.

Here, when the deformation of the separator due to stress resulting from volume expansion of the negative electrode during charge and discharge is excessively large, battery characteristics and/or safety of the nonaqueous electrolyte secondary battery may be decreased due to, for example, occurrence of a misalignment between the separator and the electrode.

The separator in accordance with an embodiment of the present invention is capable of preventing a deformation of the separator due to stress resulting from volume expansion of the negative electrode during charge and discharge. As a result, the separator is capable of preventing a decrease in battery characteristics and/or safety due to stress resulting from volume expansion of the negative electrode during charge and discharge of a nonaqueous electrolyte secondary battery including the separator.

From the above described matters, the “maximum value of the second derivative value” is preferably not less than 0.16.

Note that, if a “protrusion” is present on the stress-strain curve and the “protrusion” is at a position where the elongation amount exceeds 7.0 mm, the porous layer is less rigid and the separator is easily elongated. As such, a separator that provides a stress-strain curve in which a “protrusion” is present at the above position from a result of a tension test cannot prevent a decrease in battery characteristics and/or safety due to stress resulting from volume expansion of the negative electrode during charge and discharge.

In an embodiment of the present invention, it is preferable that the “protrusion” on the stress-strain curve is present at a position in an elongation amount range of 4.0 mm to 6.0 mm, in order to optimize the strength of the porous layer itself. The fact that the “protrusion” is present at the position in the elongation amount range of 4.0 mm to 6.0 mm means that a second derivative value described in (1) or (2) below is a maximum value of the “second derivative value” in an elongation amount range of 0 mm to 7.0 mm.
(1) A “second derivative value” which is calculated from a “first derivative value” in a section in which the elongation amount is 4.0 mm to 4.5 mm and a “first derivative value” in a section in which the elongation amount is 4.5 mm to 5.0 mm.
(2) A “second derivative value” which is calculated from a “first derivative value” in a section in which the elongation amount is 5.0 mm to 5.5 mm and a “first derivative value” in a section in which the elongation amount is 5.5 mm to 6.0 mm.

The following description will discuss characteristics and the like of members constituting the separator in accordance with an embodiment of the present invention.

[Physical Properties of Porous Film]

The porous film in accordance with an embodiment of the present invention has therein many pores connected to one another. This allows a gas and a liquid to pass through the porous film from one side to the other side. The porous film serves as a base material of the separator. The porous film can be one that imparts a shutdown function to the separator by, when a battery generates heat, melting and thereby making the separator non-porous.

The porous film is a porous film which contains a polyolefin-based resin as a main component. Note that the phrase “contains a polyolefin-based resin as a main component” means that the porous film contains a polyolefin-based resin at a proportion of not less than 50% by weight, preferably not less than 90% by weight, and more preferably not less than 95% by weight, relative to the entire amount of materials of which the porous film is made.

The polyolefin-based resin which the porous film contains as a main component is not limited to any particular one. Examples of the polyolefin-based resin include homopolymers and copolymers which are each a thermoplastic resin and which are each obtained by polymerizing one or more monomers such as ethylene, propylene, 1-butene, 4-methyl-1-pentene, and/or 1-hexene. Specific examples of the homopolymers include polyethylene, polypropylene, and polybutene. Specific examples of the copolymers include an ethylene-propylene copolymer. The porous film can be a layer which contains one type of polyolefin-based resin or can be alternatively a layer which contains two or more types of polyolefin-based resins. Among these polyolefin-based resins, polyethylene is more preferable because polyethylene makes it possible to prevent (shut down) a flow of an excessively large electric current at a lower temperature, and high molecular weight polyethylene which contains ethylene as a main component is particularly preferable. Note that the porous film can contain a component other than the polyolefin-based resin, provided that the component does not impair the function of the porous film.

Examples of the polyethylene encompass low-density polyethylene, high-density polyethylene, linear polyethylene (ethylene-α-olefin copolymer), and ultra-high molecular weight polyethylene. Among these polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable, because such a polyolefin-based resin allows the porous film and the separator to each have increased strength.

The porous film has a thickness of preferably 5 μm to 20 μm, more preferably 7 μm to 15 μm, and further preferably 9 μm to 15 μm. The porous film which has a thickness of not less than 5 μm can sufficiently achieve functions (such as a function of imparting the shutdown function) which the porous film is demanded to have. The porous film which has a thickness of not more than 20 μm allows the resulting separator to be thinner.

The pores in the porous film each have a diameter of preferably not more than 0.1 μm, and more preferably not more than 0.06 μm. This makes it possible for the separator to achieve sufficient ion permeability. Furthermore, this makes it possible to more prevent particles, which constitute an electrode, from entering the porous film.

The porous film typically has a weight per unit area of preferably 4 g/m² to 20 g/m², and more preferably 5 g/m² to 12 g/m², so as to allow a battery to have a higher weight energy density and a higher volume energy density.

The porous film has an air permeability of preferably 30 s/100 mL to 500 s/100 mL, and more preferably 50 s/100 mL to 400 s/100 mL, in terms of Gurley values. This allows the separator to achieve sufficient ion permeability.

The porous film has a porosity of preferably 20% by volume to 80% by volume, and more preferably 30% by volume to 75% by volume. This makes it possible to (i) increase the amount of an electrolyte retained in the porous film and (ii) absolutely prevent (shut down) a flow of an excessively large electric current at a lower temperature.

[Method of Producing Porous Film]

A method of producing the porous film is not limited to a particular method, and any publicly known method can be employed. For example, a method can be employed which involves adding a filler to a thermoplastic resin, forming a resulting mixture into a film, and then removing the filler, as disclosed in Japanese Patent No. 5476844.

Specifically, when, for example, the polyolefin porous film is made of the polyolefin-based resin which contains ultra-high molecular weight polyethylene and low molecular weight polyolefin that has a weight-average molecular weight of not more than 10,000, the polyolefin porous film is preferably produced by, from the viewpoint of production costs, a method including the following steps (1) through (4):
(1) kneading 100 parts by weight of ultra-high molecular weight polyethylene, 5 parts by weight to 200 parts by weight of low molecular weight polyolefin which has a weight-average molecular weight of not more than 10,000, and 100 parts by weight to 400 parts by weight of an inorganic filler such as calcium carbonate to obtain a polyolefin-based resin composition;
(2) forming the polyolefin-based resin composition into a sheet;
(3) removing the inorganic filler from the sheet which has been obtained in the step (2); and
(4) stretching the sheet which has been obtained in the step (3).

Alternatively, the polyolefin porous film may be produced by a method disclosed in any of the above-listed Patent Literatures.

The polyolefin porous film can be alternatively a commercially available product which has the above-described characteristics.

[Porous Layer]

The porous layer contains a heat-resistant resin. It is preferable that the heat-resistant resin is insoluble in the electrolyte of the battery and is electrochemically stable when the battery is in normal use.

The porous layer is formed on one surface or on both surfaces of the porous film. Here, when the porous layer is formed on one surface of the porous film, the porous layer is preferably formed on a surface of the polyolefin porous film which surface faces a positive electrode of a nonaqueous electrolyte secondary battery to be produced, and more preferably on a surface of the polyolefin porous film which surface comes into contact with the positive electrode.

Examples of the heat-resistant resin encompass polyolefins, (meth)acrylate-based resins, fluorine-containing resins, polyamide-based resins, polyimide-based resins, polyester-based resins, rubbers, resins with a melting point or glass transition temperature of not lower than 180° C., water-soluble polymers, polycarbonate, polyacetal, and polyether ether ketone. The heat-resistant resin is preferably a resin which is a nitrogen-containing aromatic resin.

Of the above heat-resistant resins, polyolefins, (meth)acrylate-based resins, fluorine-containing resins, polyamide-based resins, polyester-based resins, and water-soluble polymers are preferable.

Preferable examples of the polyolefins encompass polyethylene, polypropylene, polybutene, and an ethylene-propylene copolymer.

Examples of the fluorine-containing resins encompass polyvinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

As the polyamide-based resins, aramid resins such as aromatic polyamides and wholly aromatic polyamides (which are nitrogen-containing aromatic resins) are preferable.

Specific examples of the aramid resins encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, a metaphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Among these aramid resins, poly(paraphenylene terephthalamide) is more preferable.

It is possible to use only one of the above heat-resistant resins, or two or more of the above heat-resistant resins in combination. The porous layer may contain fine particles. The term “fine particles” herein means organic fine particles or inorganic fine particles generally referred to as a filler. The fine particles are preferably electrically insulating fine particles. Examples of the organic fine particles encompass resin fine particles. Examples of the inorganic fine particles encompass fillers made of inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. It is possible to use only one type of the above fine particles, or two or more types of the above fine particles in combination.

The porous layer contains the fine particles in an amount of preferably 1% by volume to 60% by volume, and more preferably 5% by volume to 50% by volume, with respect to 100% by volume of the porous layer.

The porous layer has a thickness of preferably 0.5 μm to 15 μm per layer, and more preferably 1 μm to 10 μm per layer. Setting the thickness of the porous layer to be not less than 0.5 μm per layer makes it possible to sufficiently prevent an internal short circuit caused by, for example, breakage of the nonaqueous electrolyte secondary battery, and also to retain a sufficient amount of the electrolyte in the porous layer. Setting the thickness of the porous layer to be not more than 15 μm per layer makes it possible to prevent a decrease in a rate characteristic or cycle characteristic.

The weight per unit area of the porous layer is preferably 3.0 g/m² to 10 g/m² per layer and more preferably 3.2 g/m² to 7.0 g/m² per layer.

For the purpose of achieving sufficient ion permeability, the porosity of the porous layer is preferably 20% by volume to 90% by volume, and more preferably 30% by volume to 80% by volume. In order for the nonaqueous electrolyte secondary battery separator to have sufficient ion permeability, the pore diameter of each pore of the porous layer is preferably not more than 3 μm, and more preferably not more than 1 μm.

[Physical Properties, Etc. Of Separator]

The separator has a thickness of preferably 5.5 μm to 45 μm and more preferably 6 μm to 25 μm.

The separator has an air permeability of preferably 100 s/100 mL to 350 s/100 mL, and more preferably 100 s/100 mL to 300 s/100 mL, in terms of Gurley values.

Impact absorption energy in the MD calculated from a result of a Charpy test of the separator is preferably not less than 0.20 J, and more preferably not less than 0.22 J. The Charpy test is carried out by a method in conformity to JIS K7111-1 (2012) using a strip-shaped sample that is cut out from the separator, that measures 80 mm×10 mm, and that has a longitudinal direction along the MD.

The separator may include, as necessary, another porous layer other than the porous film and the porous layer, provided that the other porous layer does not prevent attainment of an object of an embodiment of the present invention. Examples of the other porous layer encompass publicly known porous layers such as a heat-resistant layer, an adhesive layer, and a protective layer.

[Method of Producing Porous Layer and Separator]

A method of producing the porous layer and the separator may be, for example, a method involving: applying a coating solution to one or both surfaces of the porous film, the coating solution containing the resin contained in the porous layer; and depositing the porous layer by drying the coating solution.

The coating solution contains a resin to be contained in the porous layer. The coating solution may contain the fine particles which may be contained in the porous layer. The coating solution can be prepared typically by (i) dissolving, in a solvent, the resin that can be contained in the porous layer and (ii) dispersing, in the solvent, the fine particles. The solvent in which the resin is to be dissolved is not limited to any particular one and also serves as a dispersion medium in which the fine particles are to be dispersed. Depending on the solvent, the resin may be an emulsion.

The coating solution may be formed by any method, provided that the coating solution can satisfy conditions, such as a resin solid content (resin concentration) and a fine particle amount, which are necessary for obtaining a desired porous layer.

A method of applying the coating solution to the porous film is not limited to any particular one. As the coating solution applying method, a conventionally publicly known method can be employed. Specific examples of such a method include a gravure coater method, a dip coater method, a bar coater method, and a die coater method.

The separator in accordance with an embodiment of the present invention can be produced by adjusting, to a suitable range, (i) a proportion between a part that is easily deformed (e.g., porous film) and a part that is not easily deformed (e.g., porous layer) with respect to externally applied stress and (ii) ease of deformation (rigidity) of each of the parts. The method for carrying out the above described adjustment is not limited to any particular one. For example, the method can be a method in which, at the time of producing the porous layer, (i) the coating solution is applied to the porous film with use of a coating bar and a clearance of the coating bar is adjusted to a specific range, and (ii) an opposite surface impregnation method is employed as a method of applying the coating solution to the porous film.

When the coating solution is applied to the porous film with use of a coating bar, a weight per unit area of the resulting porous layer can be controlled by adjusting the clearance of the coating bar. The “clearance of the coating bar” refers to a distance between (i) a surface of the porous film to which the coating solution is applied and (ii) a surface of the coating bar which faces that surface. It is known that the porous layer has higher rigidity as its weight per unit area increases. Therefore, by adjusting the clearance of the coating bar to a range in which a porous layer having the foregoing preferable weight per unit area can be obtained, it is possible to adjust the rigidity of the porous layer to a suitable range, and to control the “maximum value of the second derivative value” to a suitable range of not less than 0.15.

When the coating solution is applied to the porous film, a part of the heat-resistant resin contained in the coating solution may permeate into the porous film. At this time, characteristics such as an internal structure and rigidity of the porous film may vary. In such a case, the “maximum value of the second derivative value” may be less than 0.15, because the ease of deformation of the entire separator with respect to externally applied stress varies.

As a method of preventing the permeation of the heat-resistant resin into the porous film, for example, an opposite surface impregnation method is known. In the opposite surface impregnation method, the coating solution is applied to one surface of the porous film, and a surface opposite to the surface to which the coating solution is applied is impregnated with a solvent such as, for example, N-methyl-2-pyrrolidone (NMP). Therefore, by employing the “opposite surface impregnation method”, it is possible to prevent the “maximum value of the second derivative value” from becoming less than 0.15.

Therefore, at the time of producing the porous layer, it is preferable to (i) apply the coating solution to the porous film with use of a coating bar, (ii) adjust a clearance of the coating bar to a preferable range, and (iii) employ the opposite surface impregnation method. This makes it possible to efficiently produce the separator in which the “maximum value of the second derivative value” is controlled to a suitable range of not less than 0.15.

The suitable range of the clearance of the coating bar can vary depending on various production conditions for producing a porous layer, such as a drying temperature for drying the coating solution. The clearance of the coating bar is preferably in a range of 80 μm to 140 μm under general production conditions.

### Embodiment 2: Nonaqueous Electrolyte Secondary Battery Member, and Embodiment 3: Nonaqueous Electrolyte Secondary Battery

A nonaqueous electrolyte secondary battery member in accordance with Embodiment 2 of the present invention includes a positive electrode, the nonaqueous electrolyte secondary battery separator in accordance with Embodiment 1 of the present invention, and a negative electrode, the positive electrode, the nonaqueous electrolyte secondary battery separator, and the negative electrode being arranged in this order.

A nonaqueous electrolyte secondary battery in accordance with Embodiment 3 of the present invention includes the nonaqueous electrolyte secondary battery separator in accordance with Embodiment 1 of the present invention.

The nonaqueous electrolyte secondary battery can be, for example, a nonaqueous secondary battery that achieves an electromotive force through doping with and dedoping of lithium, and can include a nonaqueous electrolyte secondary battery member including (i) a positive electrode, (ii) the nonaqueous electrolyte secondary battery separator, and (iii) a negative electrode, the positive electrode, the nonaqueous electrolyte secondary battery separator, and the negative electrode being arranged in this order. Note that constituent elements of the nonaqueous electrolyte secondary battery other than the nonaqueous electrolyte secondary battery separator are not limited to those described below.

The nonaqueous electrolyte secondary battery is typically configured so that a battery element is enclosed in an exterior member, the battery element including (i) a structure in which the negative electrode and the positive electrode face each other and sandwich the nonaqueous electrolyte secondary battery separator and (ii) an electrolyte with which the structure is impregnated. The nonaqueous electrolyte secondary battery is particularly preferably a lithium-ion secondary battery. Note that the doping refers to occlusion, support, adsorption, or insertion, and refers to a phenomenon in which lithium ions enter an active material of an electrode (e.g., a positive electrode).

The nonaqueous electrolyte secondary battery member includes the separator. A separator which does not have the “protrusion” is easily deformed when a load is applied, and therefore battery characteristics are easily impaired. In contrast, the separator in accordance with an embodiment of the present invention has the “protrusion” on the stress-strain curve in the elongation amount range of 0 mm to 7.0 mm. Therefore, the separator in accordance with an embodiment of the present invention is difficult to deform when a load is applied, and therefore battery characteristics are easily maintained. As such, the nonaqueous electrolyte secondary battery member brings about the effect of making it possible to produce a nonaqueous electrolyte secondary battery having excellent battery characteristics and/or excellent safety.

The nonaqueous electrolyte secondary battery includes the separator. As such, the nonaqueous electrolyte secondary battery brings about the effect of having excellent battery characteristics and/or excellent safety.

[Positive Electrode]

The positive electrode included in (i) the nonaqueous electrolyte secondary battery member and (ii) the nonaqueous electrolyte secondary battery is not limited to a particular one, provided that the positive electrode is one that is typically used in a nonaqueous electrolyte secondary battery. Examples of the positive electrode include a positive electrode sheet having a structure in which an active material layer including a positive electrode active material and a binding agent is formed on a current collector. The active material layer may further contain an electrically conductive agent.

Examples of the positive electrode active material include materials each capable of being doped with and dedoped of lithium ions. Specific examples of such materials encompass lithium complex oxides each containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents can be used in combination.

Examples of the binding agent encompass (i) fluorine-based resins such as polyvinylidene fluoride, (ii) acrylic resin, and (iii) styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

Examples of a method for producing the positive electrode in sheet form encompass: a method in which a positive electrode active material, an electrically conductive agent, and a binding agent are pressure-molded on a positive electrode current collector; and a method in which (i) a positive electrode active material, an electrically conductive agent, and a binding agent are formed into a paste with use of a suitable organic solvent, (ii) then, a positive electrode current collector is coated with the paste, and (iii) subsequently, the paste is dried and then pressured so that the paste is firmly fixed to the positive electrode current collector.

[Negative Electrode]

The negative electrode included in (i) the nonaqueous electrolyte secondary battery member and (ii) the nonaqueous electrolyte secondary battery is not limited to a particular one, provided that the negative electrode is one that is typically used in a nonaqueous electrolyte secondary battery. The negative electrode can be, for example, a negative electrode sheet having a structure in which an active material layer, containing a negative electrode active material and a binding agent, is formed on a current collector. The active material layer may further contain an electrically conductive agent.

Examples of the negative electrode active material encompass (i) materials capable of being doped with and dedoped of lithium ions, (ii) a lithium metal, and (iii) a lithium alloy. Examples of the materials capable of being doped with and dedoped of lithium ions encompass carbonaceous materials. Examples of the carbonaceous materials encompass natural graphite, artificial graphite, cokes, carbon black, and pyrolytic carbons.

Examples of the negative electrode current collector include Cu, Ni, and stainless steel. Among these, Cu is especially more preferable because Cu is not easily alloyed with lithium in a lithium secondary battery and is easily processed into a thin film.

Examples of a method for producing the negative electrode in sheet form encompass: a method in which a negative electrode active material is pressure-molded on a negative electrode current collector; and a method in which (i) a negative electrode active material is formed into a paste with use of a suitable organic solvent, (ii) then, a negative electrode current collector is coated with the paste, and (iii) subsequently, the paste is dried and then pressured so that the paste is firmly fixed to the negative electrode current collector. The paste preferably contains an electrically conductive agent as described above and a binding agent as described above.

[Nonaqueous Electrolyte]

A nonaqueous electrolyte in the nonaqueous electrolyte secondary battery is not limited to any particular one, provided that the nonaqueous electrolyte is one that is generally used for a nonaqueous electrolyte secondary battery. The nonaqueous electrolyte can be one prepared by, for example, dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent to be contained in the nonaqueous electrolyte encompass carbonates, ethers, esters, nitriles, amides, carbamates, and sulfur-containing compounds, and fluorine-containing organic solvents each obtained by introducing a fluorine group into any of these organic solvents. It is possible to use only one kind of the above organic solvents or two or more kinds of the above organic solvents in combination.

[Main Points]

An embodiment of the present invention may include the features as described in <1> through <7> below.

<1> A nonaqueous electrolyte secondary battery separator including a polyolefin porous film and a porous layer formed on one surface or on both surfaces of the polyolefin porous film, the porous layer containing a heat-resistant resin, and a maximum value of a second derivative value being not less than 0.15, where the second derivative value is calculated based on first derivative values which have been obtained at intervals of 0.5 mm of an elongation amount in a range of a value of X of 0 mm to 7.0 mm on a stress-strain curve, and the stress-strain curve is obtained from a result of a tension test carried out with respect to the nonaqueous electrolyte secondary battery separator while setting an elongation amount as an X-axis and stress as a Y-axis.

<2> The nonaqueous electrolyte secondary battery separator described in <1>, in which: impact absorption energy in a machine direction is not less than 0.20 J, the impact absorption energy being calculated from a result of a Charpy test.

<3> The nonaqueous electrolyte secondary battery separator described in <1> or <2>, in which: a weight per unit area of the porous layer is not less than 3.0 g/m² and not more than 10.0 g/m².

<4> The nonaqueous electrolyte secondary battery separator described in any one of <1> through <3>, in which: the heat-resistant resin is a nitrogen-containing aromatic resin.

<5> The nonaqueous electrolyte secondary battery separator described in <4>, in which: the nitrogen-containing aromatic resin is an aramid resin.

<6> A nonaqueous electrolyte secondary battery member including: a positive electrode; the nonaqueous electrolyte secondary battery separator described in any one of <1> through <5>; and a negative electrode, the positive electrode, the nonaqueous electrolyte secondary battery separator, and the negative electrode being arranged in this order.

<7> A nonaqueous electrolyte secondary battery including: the nonaqueous electrolyte secondary battery separator described in any one of <1> through <5>.

Note that the scope of the separator, the nonaqueous electrolyte secondary battery member, and the nonaqueous electrolyte secondary battery in accordance with an embodiment of the present invention can encompass any combination of matters described in the foregoing features within the scope of the claims.

### EXAMPLES

The following description will discuss embodiments of the present invention in more detail with reference to Examples and Comparative Examples. Note, however, that the present invention is not limited to such Examples and Comparative Examples.

[Measurement Methods]

The methods described below were used to measure physical properties and the like of the separators, porous films, and porous layers produced in Examples 1 through 3 and in Comparative Examples 1 through 3.

[Thickness]

A thickness of the porous film was measured with use of a high-precision digital measuring device (VL-50) manufactured by Mitutoyo Corporation.

[Weight Per Unit Area]

A sample in the form of an 8 cm square was cut out from each of porous films which had been used in Examples and Comparative Examples, and a weight Wₐ [g] of the sample was measured. With use of the measured value Wₐ, a weight per unit area [g/m²] of the porous film was calculated according to expression (1) below.

Weight per unit area of porous film=(Wₐ)/(0.08×0.08) Expression (1):

A sample in the form of an 8 cm square was cut out from each of separators, and a weight W_{b} [g] of the sample was measured. With use of the measured value W_{b}, a weight per unit area [g/m²] of the separator was calculated according to expression (2) below.

Weight per unit area of separator=(W_{b})/(0.08×0.08) Expression (2):

After that, the weight per unit area of the porous film was subtracted from the weight per unit area of the separator, and thus a weight per unit area of a porous layer included in the separator was calculated.

[Air Permeability]

From the separator, a sample measuring 60 mm×60 mm was cut out. The air permeability of the sample was measured in conformity to JIS P8117.

[Porosity]

The following description assumes that the separator is constituted by constituent materials a, b, c, . . . , and n. The constituent materials are assumed to have mass compositions Wa, Wb, Wc . . . , and Wn (g/cm²). The constituent materials are assumed to have real densities da, db, dc . . . , and dn (g/cm³). The separator is assumed to have a film thickness t (cm). With use of these parameters, a porosity ε [%] of the separator was calculated according to expression (3) below.

Porosity ε of separator=[1−{(Wa/da+Wb/db+Wc/dc+ . . . +Wn/dn)/t}]×100 Expression (3):

As a real density of the used filler, a density described in product information of that filler was used. As a real density of the heat-resistant resin, a density described in Literature 1 (TAKASHI NOMA, Sen'I Gakkaishi, “Development trend of synthetic fibers”, special issue p. 242, “Properties and Application of Aramid Fibers”) was used. As a real density of the polyolefin porous film constituted by polyethylene, a density described in product information of the used film was used.

[Calculation of Second Derivative Value]

Stress and an elongation amount of the separator were measured by a method in conformity to the JIS K7127 standard, and a “maximum value of a second derivative value” was calculated based on the measured result. Specifically, the “maximum value of the second derivative value” was calculated by a method including the following steps (a) through (e).
(a) The separator was punched out with a JIS K6251-3 dumbbell (distance between marked lines 20 mm, width of 5 mm) such that the MD was a longitudinal direction of the separator, so that a measurement sample was obtained.
(b) The measurement sample obtained in step (a) was elongated in the MD at a rate of 10 mm/min, and a load (stress) and an elongation amount until the measurement sample was completely broken were measured. At that time, data was obtained every time the elongation amount increased by 0.02 mm. More specifically, every time the elongation amount changed by 0.02 mm, the load (stress) applied at that time was measured.
(c) The elongation amount (unit: mm) and the stress (load) (unit: MPa) obtained in step (b) were plotted while setting the elongation amount as an X-axis (horizontal axis) and the stress as a Y-axis (vertical axis), and thus a stress-strain curve was obtained.
(d) In a range of a value of X of 0 mm to 7.0 mm on the stress-strain curve obtained in step (c), inclinations (first derivative values) of the load were calculated at intervals of 0.5 mm of the elongation amount. That is, the elongation amount was partitioned into sections at intervals of 0.5 mm (e.g., 0.0 mm to 0.5 mm, 0.5 mm to 1.0 mm), and then an inclination obtained when the stress-strain curve was approximated to a straight line was calculated for each of the sections, and thus a “first derivative value” was obtained. This calculation was carried out until the elongation amount reached 7.0 mm. Note, however, that, if the measurement sample (i.e., the separator) was completely broken before the elongation amount reached 7.0 mm, the first derivative value was calculated in each of sections in a calculable range, i.e., a range of the elongation amount until the measurement sample was completely broken.
(e) Among the first derivative values obtained in step (d) in the respective sections, a difference between first derivative values of two successive sections was calculated as a “second derivative value”. Subsequently, a maximum value among the calculated “second derivative values” which were each obtained in two successive sections was regarded as a “maximum value of a second derivative value”.

[Charpy Impact Test]

From the separator, a strip-shaped sample measuring 80 mm×10 mm and having a longitudinal direction along the MD was cut out. With respect to the strip-shaped sample, a Charpy test was carried out in conformity to JIS K7111-1 (2012), and thus impact absorption energy [unit: J] of the separator in the MD was measured.

<Preparation of Nonaqueous Electrolyte Secondary Battery for Test>
1. A positive electrode and a negative electrode were prepared. The composition of a positive electrode active material was such that the amount of LiNi_{0.8}Co_{0.15}Al_{0.05}O₂ was 92 parts by weight, the amount of an electrically conductive agent was 4 parts by weight, and the amount of a binding agent was 4 parts by weight. The positive electrode active material was applied to both surfaces of a base material in a weight per unit area of 11.5 g/cm² per surface. The composition of a negative electrode active material was such that the amount of natural graphite was 95.7 parts by weight, the amount of an electrically conductive agent was 0.5 parts by weight, and the amount of a binding agent was 3.8 parts by weight. The negative electrode active material was applied to both surfaces of a base material in a weight per unit area of 7.8 g/cm² per surface.
2. A nonaqueous electrolyte secondary battery member was produced. A tab lead and an aluminum-laminated packaging material for exterior were prepared. The electrodes and the separator were alternately arranged. The laminated body obtained by the alternate arrangement was dried under reduced pressure at 80° C. for 8 hours. Subsequently, the tab lead was welded to the laminated body with ultrasonic waves, and the aluminum-laminated packaging material for exterior was then heat-sealed. Thus, the laminated body was packaged to produce a laminated element. At that time, the laminated element had 10 positive electrode layers, and 11 negative electrode layers. A design capacity was 2 Ah.
3. Each of the laminated elements was placed in a dry box (with dew point of not more than −50° C.), and the laminated element was dried under reduced pressure at 80° C. for 8 hours. Then, a nonaqueous electrolyte was poured into the laminated element at normal temperature under normal pressure. The nonaqueous electrolyte used was obtained as follows: in a mixed solvent obtained by mixing ethylenecarbonate and ethyl methyl carbonate at 3:7 (volume ratio), LiPF₆ was dissolved such that the concentration was 1 mol/L, and then 1% by weight of vinylene carbonate was added as an additive.
4. Vacuum impregnation and temporary sealing under reduced pressure were carried out, and thus a nonaqueous electrolyte secondary battery for a test was prepared. After that, the nonaqueous electrolyte secondary battery for a test was left at 20° C. for 24 hours for stabilization.

[Initial Charge and Discharge and Degassing]

The nonaqueous electrolyte secondary battery for a nail penetration test prepared by the above method was subjected to CC-CV charge at an ending voltage of 4.2 V and a charge current value of 0.2 C, under a cutoff condition for 12 hours (where the value of an electric current at which a battery rated capacity of the prepared battery was discharged in one hour was assumed to be 1 C). Subsequently, in a dry box (with dew point of not more than −50° C.), degassing and vacuum sealing of the nonaqueous electrolyte secondary battery were carried out.

[Initial Discharge Test and 2nd Charge-Discharge Test]

An initial discharge test and a 2nd charge-discharge test were carried out on the nonaqueous electrolyte secondary battery after the degassing and the vacuum sealing. The first discharge was carried out with CC discharge at an ending voltage of 2.7 V and a charge current value of 0.2 C. The 2nd charge-discharge test was carried out with CC-CV at an ending voltage of 4.2 V and a charge current value of 0.2 C for the charge, and the cutoff condition was set to 6.5 hours or 0.02 C. Subsequently, the discharge was carried out with CC discharge at an ending voltage of 2.7 V and a charge-discharge current of 0.2 C.

[Nail Penetration Test]

A nail penetration test was carried out with use of a nonaqueous electrolyte secondary battery which included the separator and which had undergone the initial discharge test and the 2nd charge-discharge test. As pre-test adjustment, the nonaqueous electrolyte secondary battery was charged to be a fully charged state (SOC of 100%). The charge conditions were as follows: CC-CV charge was carried out at an ending voltage of 4.2 V and an electric current value of 0.2 C, and the cutoff condition was 10 hours. The nonaqueous electrolyte secondary battery after charge was placed in a nail penetration test device under an atmosphere at 25° C. Then, a nail having a thickness of 3 mm and a tip angle of 600 was caused to pierce through the nonaqueous electrolyte secondary battery at a rate of 100 mm/s. Then, a voltage after 3 seconds (hereafter referred to as “voltage after 3 seconds from the nail penetration test”) was measured.

### Production Example 1: Preparation of Aramid Resin

Poly(paraphenylene terephthalamide), which is a kind of aramid resins, was synthesized by the following method. A separable flask which had a capacity of 3 L and was provided with a stirring blade, a thermometer, a nitrogen incurrent canal, and a powder addition port was used as a container for synthesis. Into the separable flask which had been sufficiently dried, 2200 g of NMP was introduced. Then, 151.07 g of calcium chloride powder was added thereto, and was completely dissolved while rising the temperature to 100° C. Thus, a solution A was obtained. The calcium chloride powder had been dried in advance in vacuum at 200° C. for 2 hours.

Next, a solution temperature of the solution A was returned to room temperature, and 68.23 g of paraphenylenediamine was added and completely dissolved. Thus, a solution B was obtained. While the temperature of the solution B was maintained at 20±2° C., 124.97 g of dichloride terephthalate was added in four separate portions at intervals of approximately 10 minutes to obtain a solution C. After that, the solution C was allowed to mature for 1 hour while being continuously stirred at 150 rpm and while the temperature was kept at 20±2° C. As a result, an aramid polymerization liquid containing 6% by weight of poly(paraphenylene terephthalamide) was obtained.

### Production Example 2: Preparation of Coating Solution

Into a flask, 100 g of the aramid polymerization liquid obtained in Production Example 1 was weighed and introduced, and 6.0 g of alumina A (average particle size: 13 nm) and 6.0 g of alumina B (average particle size: 640 nm) were added to obtain a dispersion solution A2. In the dispersion solution A2, a weight ratio of poly(paraphenylene terephthalamide), alumina A, and alumina B was 1:1:1. Next, NMP was added to the dispersion solution A2 so that a solid content was 6.0% by weight, and the resulting mixture was stirred for 240 minutes to obtain a dispersion solution B2. The term “solid content” here refers to a total weight of poly(paraphenylene terephthalamide), alumina A, and alumina B. Next, 0.73 g of calcium carbonate was added to the dispersion solution B2, and the resulting mixture was stirred for 240 minutes to neutralize the dispersion solution B2. The neutralized dispersion solution B2 was defoamed under reduced pressure to prepare a coating solution (1) in slurry form.

### Example 1

As a porous base material, a polyolefin porous film (thickness: 10.5 μm) which was constituted by polyethylene was used. The coating solution (1) obtained in Production Example 2 was applied to one surface of the polyolefin porous film with use of a coating bar. When carrying out the application, a surface opposite to the surface of the polyolefin porous film to which the coating solution (1) was applied was in a state of being impregnated with NMP (opposite surface impregnation). A clearance of the coating bar was set to 91 μm. After the application, poly(paraphenylene terephthalamide) was deposited in an atmosphere at a temperature of 60° C. and a relative humidity of 70%. Next, the applied material on which the poly(paraphenylene terephthalamide) had been deposited was immersed in ion-exchange water, and calcium chloride and the solvent were removed from the applied material. Next, the applied material from which calcium chloride and the solvent had been removed was dried at 80° C., and thus a nonaqueous electrolyte secondary battery separator (1) was obtained.

### Example 2

A nonaqueous electrolyte secondary battery separator (2) was obtained in a manner similar to that of Example 1, except that the clearance was set to 113 μm.

### Example 3

A nonaqueous electrolyte secondary battery separator (3) was obtained in a manner similar to that of Example 1, except that the clearance was set to 132 μm.

### Comparative Example 1

A comparative nonaqueous electrolyte secondary battery separator (1) was obtained in a manner similar to that of Example 1, except that the clearance was set to 48 μm.

### Comparative Example 2

A comparative nonaqueous electrolyte secondary battery separator (2) was obtained in a manner similar to that of Example 1, except that the clearance was set to 68 μm.

### Comparative Example 3

A comparative nonaqueous electrolyte secondary battery separator (2) was prepared in a manner similar to that of Example 1, except that the clearance was set to 59 μm, and the coating solution (1) was applied to one surface of the porous film without carrying out NMP impregnation (opposite surface impregnation) on the porous base material.

### CONCLUSION

Table 1 shows physical property values of the nonaqueous electrolyte secondary battery separators (1) through (3) produced in Examples 1 through 3 and the comparative nonaqueous electrolyte secondary battery separators (1) through (3) produced in Comparative Examples 1 through 3. Table 1 also shows characteristics of nonaqueous electrolyte secondary batteries for the test which were produced by the foregoing method using these separators. In Table 1, “-” indicates that a value was not measured.

| | | | | | | Nonaqueous |
|---|---|---|---|---|---|---|
| | | Nonaqueous electrolyte secondary battery separator | | | | electrolyte |
| | | | | Maximum | | secondary battery |
| | | | | value | Impact | Voltage after 3 |
| | Porous layer | | | of second | absorption | seconds from nail |
| | Weight per unit | Air permeability | Porosity | derivative | energy in | penetration test |
| | area [g/m²] | [s/100 mL] | [%] | value | MD [J] | [V] |
| Example 1 | 3.4 | 335 | 48 | 0.16 | 0.22 | — |
| Example 2 | 4.3 | 400 | 49 | 0.21 | 0.24 | 2.5 |
| Example 3 | 6.1 | 357 | 55 | 0.46 | — | 2.5 |
| Comparative | 1.7 | 246 | 48 | −0.01 | 0.17 | — |
| Example 1 | | | | | | |
| Comparative | 2.6 | 280 | 48 | 0.07 | 0.19 | 1.0 |
| Example 2 | | | | | | |
| Comparative | 3.6 | 338 | 50 | −1.20 | 0.11 | — |
| Example 3 | | | | | | |

As shown in Table 1, the nonaqueous electrolyte secondary battery separators (1) through (3) produced in Examples 1 through 3 each have a “maximum value of a second derivative value” of not less than 0.15. In contrast, the comparative nonaqueous electrolyte secondary battery separators (1) through (3) produced in Comparative Examples 1 through 3 each have a “maximum value of a second derivative value” of less than 0.15. In addition, the nonaqueous electrolyte secondary battery separators (1) and (2) have higher impact absorption energy in the MD, which has been measured in the Charpy test, and have excellent strength against external impact, as compared with the comparative nonaqueous electrolyte secondary battery separators (1) through (3). In addition, the nonaqueous electrolyte secondary batteries including the nonaqueous electrolyte secondary battery separators (2) and (3) each have a higher voltage after 3 seconds from the nail penetration test, and is excellent in safety, as compared with the nonaqueous electrolyte secondary battery including the comparative nonaqueous electrolyte secondary battery separator (2).

As such, it has been found that the nonaqueous electrolyte secondary battery separator in accordance with an embodiment of the present invention which has the “maximum value of the second derivative value” of not less than 0.15 is excellent in strength against external impact, and is excellent in safety. Therefore, the nonaqueous electrolyte secondary battery separator can suitably prevent a deformation of the separator due to stress resulting from volume expansion of the negative electrode during charge and discharge. It has been also found that the nonaqueous electrolyte secondary battery separator can prevent a decrease in battery characteristics and/or safety due to a deformation of the separator.

In addition, from a comparison between Example 1 and Comparative Example 3 of the present application, it has been found that, in some cases, it is impossible to control, to a suitable range, the ease of deformation of the entire separator with respect to externally applied stress merely by increasing the weight per unit area of the porous layer. In other words, it has been found that the nonaqueous electrolyte secondary battery separator in accordance with an embodiment of the present invention can be produced by adjusting the weight per unit area of the porous layer and also by employing opposite surface impregnation or the like.

### INDUSTRIAL APPLICABILITY

The separator in accordance with an embodiment of the present invention can be used in production of a nonaqueous electrolyte secondary battery that can prevent a decrease in battery characteristics and/or safety caused by a deformation of the separator due to stress resulting from volume expansion of the negative electrode during charge and discharge.

1. A nonaqueous electrolyte secondary battery separator comprising a polyolefin porous film and a porous layer formed on one surface or on both surfaces of the polyolefin porous film,
the porous layer containing a heat-resistant resin, and
a maximum value of a second derivative value being not less than 0.15, where the second derivative value is calculated based on first derivative values which have been obtained at intervals of 0.5 mm of an elongation amount in a range of a value of X of 0 mm to 7.0 mm on a stress-strain curve, and the stress-strain curve is obtained from a result of a tension test carried out with respect to said nonaqueous electrolyte secondary battery separator while setting an elongation amount as an X-axis and stress as a Y-axis.

2. The nonaqueous electrolyte secondary battery separator as set forth in claim 1, wherein:
impact absorption energy in a machine direction is not less than 0.20 J, the impact absorption energy being calculated from a result of a Charpy test.

3. The nonaqueous electrolyte secondary battery separator as set forth in claim 1, wherein:
a weight per unit area of the porous layer is not less than 3.0 g/m² and not more than 10.0 g/m².

4. The nonaqueous electrolyte secondary battery separator as set forth in claim 1, wherein:
the heat-resistant resin is a nitrogen-containing aromatic resin.

5. The nonaqueous electrolyte secondary battery separator as set forth in claim 4, wherein:
the nitrogen-containing aromatic resin is an aramid resin.

6. A nonaqueous electrolyte secondary battery member comprising:
a positive electrode;
a nonaqueous electrolyte secondary battery separator recited in claim 1; and
a negative electrode,
the positive electrode, the nonaqueous electrolyte secondary battery separator, and the negative electrode being arranged in this order.

7. A nonaqueous electrolyte secondary battery comprising:
a nonaqueous electrolyte secondary battery separator recited in claim 1.
